(19) United States
(12) Patent Application Publication
(10) Pub. No.: US 2013/0057593 A1
(43) Pub. Date: Mar. 7, 2013

(54) LIGHTING APPARATUS

(71) Applicant: Masashi Morishita, Isehara-shi (JP)

(72) Inventor: Masashi Morishita, Isehara-shi (JP)

(73) Assignee: CANON KABUSHIKI KAISHA, Tokyo (JP)

(21) Appl. No.: 13/596,732

(22) Filed: Aug. 28, 2012

(30) Foreign Application Priority Data
Sep. 5, 2011 (JP) 2011-192803

(51) Int. Cl. F21V 9/00; G02F 1/13357; G09G 3/36; G09F 13/04

(52) U.S. Cl. 345/690; 362/231; 362/97.2; 349/61; 345/102

(57) ABSTRACT

A lighting apparatus according to the present invention is configured from a plurality of blocks controllable individually for brightness or color, wherein each of the blocks comprises a plurality of light emitting devices including a plurality of white light emitting devices and a plurality of colored light emitting devices, and the plurality of light emitting devices of each of the blocks are arranged in a matrix so that the white light emitting devices are positioned at four corners.

### BACKGROUND OF THE INVENTION

1. Field of the Invention

The present invention relates to a lighting apparatus.

2. Description of the Related Art

In recent years, a liquid crystal display (LCD) apparatus is known as a display apparatus of high definition, broad color gamut, and low power consumption.

There are two methods for displaying the intended color temperature in a liquid crystal display apparatus. One method is to configure a backlight apparatus using a white light source (white light emitting device), and adjust the color temperature by image signal processing. The other method is to configure a backlight apparatus using a plurality of primary color lights sources (colored light emitting devices) such as red, green, and blue, and achieve additive color mixing by lighting the foregoing primary color light sources at a luminous intensity ratio that realizes the intended color temperature.

Of the two methods described above, while the method of configuring the backlight apparatus (lighting apparatus) by using only a white light source yields superior light emitting efficiency, the display color gamut becomes narrow. Meanwhile, while the method of configuring the backlight apparatus by using a plurality of primary color lights sources is able to broaden the display color gamut, it is difficult to achieve low power consumption since the light emitting efficiency of the respective light sources is low.

Thus, considered may be reducing the power consumption of the backlight apparatus via local dimming control. Specifically, by classing the light source of the backlight apparatus into a plurality of blocks (areas) which are obtained by dividing the area of the screen and driving the light source individually for each block, the power consumption can be reduced. Moreover, if this kind of local dimming control is used, it is possible to improve the contrast of the image (Japanese Patent Application Publication No. 2009-175740).

Moreover, Japanese Patent Application Publication No. 2005-243347 discloses a backlight apparatus in which a plurality of light sources are arrayed at regular intervals, the emission color is different among the light sources which are adjacent in the array direction, and lights emitted from the plurality of light sources are mixed and emitted as illuminating light. With the backlight apparatus disclosed in Japanese Patent Application Publication No. 2005-243347, at least one light source in which the emission color is the emission color of the illuminating light is disposed to become the light source that is closest to the side wall.

### SUMMARY OF THE INVENTION

Nevertheless, when the contrast of the image is improved by performing local dimming control to the backlight apparatus which realizes white light by using a plurality of colored light emitting devices (for instance, primary color light emitting diodes (LEDs)), unintended coloring is generated in the image. For example, when the light source of one block is independently lit, it is difficult to mix the color of light from the primary color LED of the edge of that block since there are no LEDs of other colors emitting light outside the primary color LED. In addition, since light from the foregoing primary color LED of the edge will leak to the peripheral blocks (unlit blocks), unintended coloring is generated in the unlit blocks.

Moreover, the technology disclosed in Japanese Patent Application Publication No. 2005-243347 is technology of reducing the color unevenness around the side wall by constantly lighting the white light source. Thus, with the technology disclosed in Japanese Patent Application Publication No. 2005-243347, when the luminous intensity of the white light source near the side wall is lowered in order to give preference to the display color gamut, there is a problem in that brightness unevenness will occur. Moreover, since a backlight apparatus that can be subject to local dimming control is not assumed, the problem that unintended coloring occurs in the unlit blocks when the light source of one block is independently light is not anticipated.

The present invention is provides a lighting apparatus capable of inhibiting the generation of unintended coloring around the blocks, as well as inhibiting color unevenness and brightness unevenness.

A lighting apparatus according to the present invention is configured from a plurality of blocks controllable individually for brightness or color, wherein

each of the blocks comprises a plurality of light emitting devices including a plurality of white light emitting devices and a plurality of colored light emitting devices, and

the plurality of light emitting devices of each of the blocks are arranged in a matrix so that the white light emitting devices are positioned at four corners.

According to the present invention, it is possible to inhibit the generation of unintended coloring around the blocks, as well as inhibit color unevenness and brightness unevenness.

Further features of the present invention will become apparent from the following description of exemplary embodiments with reference to the attached drawings.

### BRIEF DESCRIPTION OF THE DRAWINGS

FIG. 1 is a block diagram showing an example of the functional configuration of the image display apparatus according to Embodiment 1;

FIG. 2 is a diagram showing an example of the arrangement of the LEDs in the LED light source unit according to Embodiment 1;

FIG. 3 is a flowchart showing an example of the operation of the image display apparatus according to Embodiment 1;

FIGS. 4A and 4B are diagrams showing an example of the input image signal and the light emitting brightness of the respective blocks;

FIG. 5 is a diagram showing an example of the arrangement of the LEDs in the LED light source unit according to Embodiment 2;

FIGS. 6A and 6B are diagrams showing an example of the arrangement of the LEDs in the LED light source unit according to Embodiment 3; and

FIGS. 7A and 7B are diagrams showing an example of the arrangement of the LEDs in the LED light source unit according to Embodiment 3.

### DESCRIPTION OF THE EMBODIMENTS

### Embodiment 1

Embodiment 1 of the present invention is now explained.

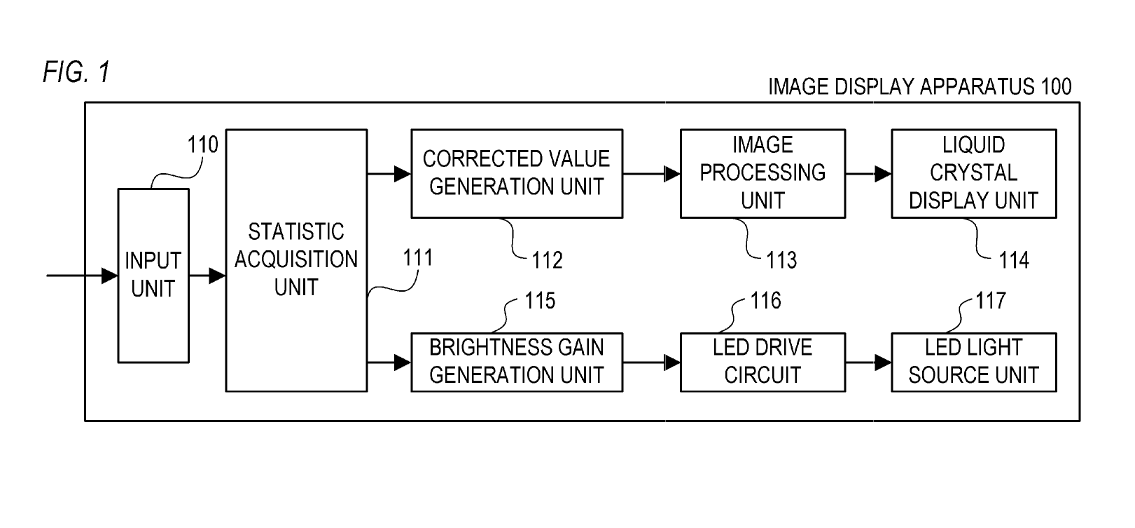

FIG. 1 is a block diagram showing an example of the functional configuration of an image display apparatus 100 (liquid crystal display apparatus) according to Embodiment 1. The image display apparatus 100 according to this embodiment is configured such that local dimming control can be performed. Specifically, the image display apparatus 100 performs, for each block (area) which is obtained by dividing the area of the screen into a plurality of areas, controlling of the brightness (light emitting brightness) or color (emission color) of the backlight apparatus (lighting apparatus), image processing, or the like.

The input unit 110 inputs an image signal from the outside, and transmits the input image signal to a statistic acquisition unit 111.

The statistic acquisition unit 111 acquires a statistic from the transmitted image signal. Specifically, the statistic acquisition unit 111 acquires, for each block, a statistic (brightness histogram or the like) of the image signal to be displayed in that block, and transmits the acquired statistic to a correction value generation unit 112 and a brightness gain generation unit 115.

The correction value generation unit 112 calculates, for each block, the surface brightness (brightness and color of light from the backlight apparatus) by using the statistic of that block that was acquired by the statistic acquisition unit 111. In addition, the correction value generation unit 112 calculates, for each block, a correction value by using the surface brightness of that block that was calculated as described above, and transmits the calculated correction value to an image processing unit 113. For example, calculated is a correction value for converting the image signal into an image signal giving consideration to the brightness and color of the light from the backlight apparatus. Specifically, calculated is a correction value for performing histogram compression or histogram stretching for inhibiting the change in the brightness (display brightness) or color (display color) of the brightest part of the image caused by the change in the brightness or color of the light from the backlight apparatus.

Note that the correction value generation unit 112 may calculate, for each block, the correction value by using only the surface brightness of that block, or calculate, for each block, the correction value by using the surface brightness of that block and the peripheral blocks. If the correction value is calculated, for each block, by using the surface brightness of that block and the peripheral blocks, image processing (image processing giving consideration to the light that leaked from the other blocks) can be performed with even greater accuracy.

The image processing unit 113 performs, for each block, image processing to the image signal by using the correction value of that block that was calculated by the correction value generation unit 112.

A liquid crystal display unit 114 is a liquid crystal panel including a plurality of liquid crystal devices. The liquid crystal display unit 114 controls the transmittance of the respective liquid crystal devices based on the image signal that was subject to image processing by the image processing unit 113. In other words, in this embodiment, the transmittance of the liquid crystal display unit 114 is controlled for each block based on the input image signal.

A brightness gain generation unit 115 calculates, for each block, the average brightness of the image signal of that block from the statistic that was acquired with the statistic acquisition unit 111. In addition, the brightness gain generation unit 115 calculates, for each block, the light emitting brightness according to the calculated average brightness of that block.

An LED drive circuit 116 causes, for each block, an LED light source unit 117 (backlight apparatus) to emit light at the light emitting brightness of that block that was calculated by the brightness gain generation unit 115. In other words, in this embodiment, the brightness (light emitting brightness) or color (emission color) of the LED light source unit 117 is controlled for each block based on the input image signal. Specifically, the light emitting brightness of the block in which a dark image is to be displayed is set to be relatively lower relative to the light emitting brightness of the block in which a bright image is to be displayed.

The LED light source unit 117 is a backlight apparatus (LED array substrate) which emits a white light based on a color mixture of white light and a plurality of primary color lights (red light, green light, blue light and the like).

Graphics, text, moving images and the like are displayed as a result of light from the backlight apparatus being transmitted through the liquid crystal panel.

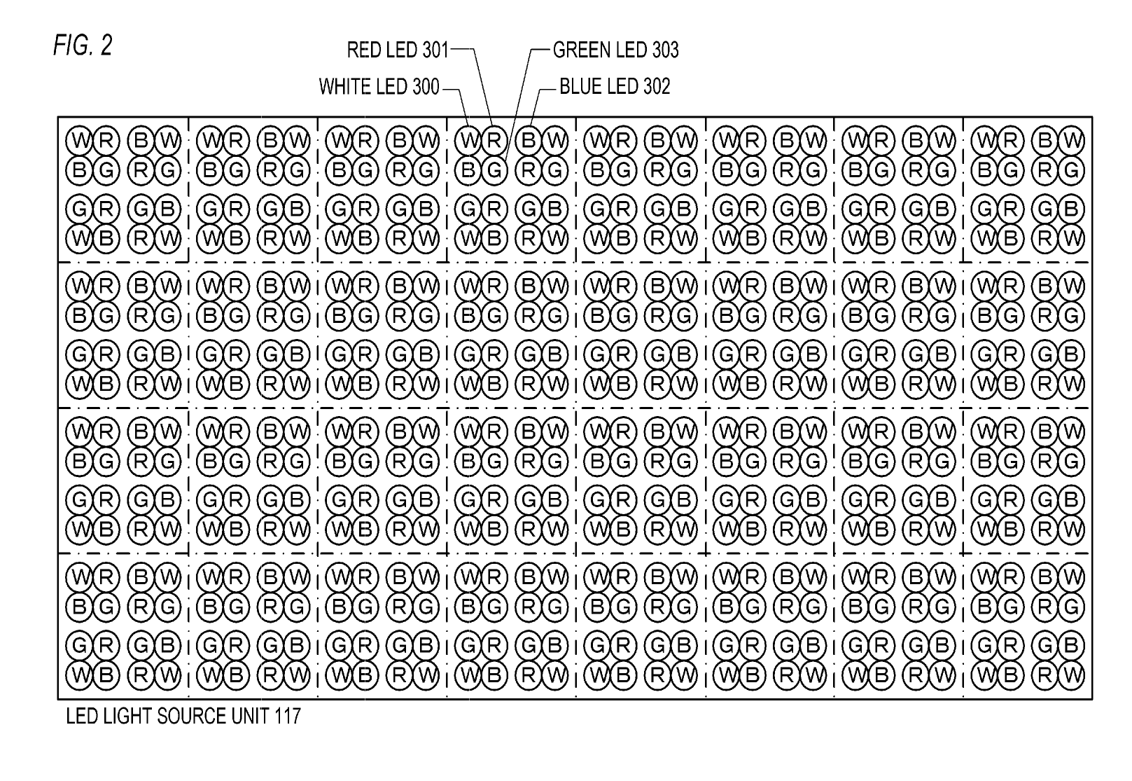

FIG. 2 is a diagram showing an example of the array of the LEDs in the LED light source unit 117 (backlight apparatus) according to this embodiment. As shown in FIG. 2, the LED light source unit 117 is a direct-type LED backlight apparatus including a plurality of LEDs arranged in a matrix. Note that, in the LED light source unit 117, a non-LED light emitting device such as an organic EL light emitting device may also be used.

As described above, the LED light source unit 117 according to this embodiment is configured such that local dimming control can be performed. In other words, the LED light source unit 117 according to this embodiment is configured from a plurality of blocks in which the brightness (light emitting brightness) or color (emission color) can be individually controlled.

In FIG. 2, the areas dividing by a dashed-dotted line represent the blocks. In the example of FIG. 2, the LED light source unit 117 is configured from a total of 32 blocks; namely, (horizontal direction)×4 (vertical direction) blocks. However, the number of blocks is not limited thereto . The number of blocks may also be a total of 2 blocks; namely, 2×1 blocks, a total of 30 blocks; namely, 10×3 blocks, or a total of 8 blocks; namely, 1×8 blocks.

As shown in FIG. 2, each block comprises a plurality of LEDs (light emitting devices) including a plurality of white LEDs 300 (white light emitting devices; W) and a plurality of primary color LEDs (colored LED; colored light emitting devices). In the example of FIG. 2, the plurality of colored light emitting devices are a red LED 301 (red light emitting device; R), a blue LED 302 (blue light emitting device; B), and a green LED 303 (green light emitting device; G).

As a result of disposing, in each block, a white LED 300 and a plurality of primary color LEDs capable of realizing white light based on a color mixture, the light emitting brightness of each block can be changed while maintaining the white balance. Consequently, the color unevenness or brightness unevenness of the light from the LED light source unit 117 can be inhibited.

Moreover, as shown in FIG. 2, the plurality of LEDs of each block are arranged in a matrix so that the white LED are positioned at the four corners.

Specifically, one group is configured from one or more white LEDs and the plurality of primary color LEDs arranged in a matrix. In addition, the plurality of LEDs of each block are configured from a plurality of groups arranged in a matrix so that the white LEDs are positioned at the four corners.

In the example of FIG. 2, one group is configured from four LEDs; namely, one white LED 300, one red LED 301, one blue LED 302, and one green LED 303 arranged in a matrix. In addition, the plurality of LEDs of each block are configured from four groups arranged in a 2×2 matrix so that the white LEDs are positioned at the four corners.

Accordingly, as a result of disposing the white LEDs at the four corners, it is possible to inhibit unintended coloring from occurring around the block. Specifically, color mixing of light from the LEDs at the four corners with light form the other LEDs is most difficult. In this embodiment, as a result of disposing the white LEDs at the four corners which are positions where color mixing is most difficult with light from the other LEDs, it is possible to approximate the color of light leaking from the periphery of the block to white. Consequently, it is possible to inhibit the generation of unintended coloring around the block in cases where, for instance, a plurality of LEDs of one block are independently lit.

Note that, in this embodiment, while one group was configured from four LEDs, the configuration is not limited thereto. One group may also be configured from four or more LEDs. For example, one group may include a plurality of white LEDs. One group may also included a colored LED (for instance, a yellow LED) other than a red LED, a blue LED, and a green LED.

Note that, in this embodiment, while the plurality of LEDs of each block were configured from four groups, the configuration is not limited thereto. The number of groups may be more than or less than four. The plurality of LEDs of each block do not have to be configured from a plurality of groups (maybe configured from one group).

Note that, in this embodiment, while the plurality of primary color LEDs of each block were configured by including four red LEDs, four green LEDs, and four blue LEDs, the configuration is not limited thereto. The number of red LEDs, green LEDs, and blue LEDs of each block may be more than or less than four. Moreover, the plurality of primary color LEDs of each block may include a colored LED (for instance, a yellow LED) other than the red LED, the blue LED, and the green LED.

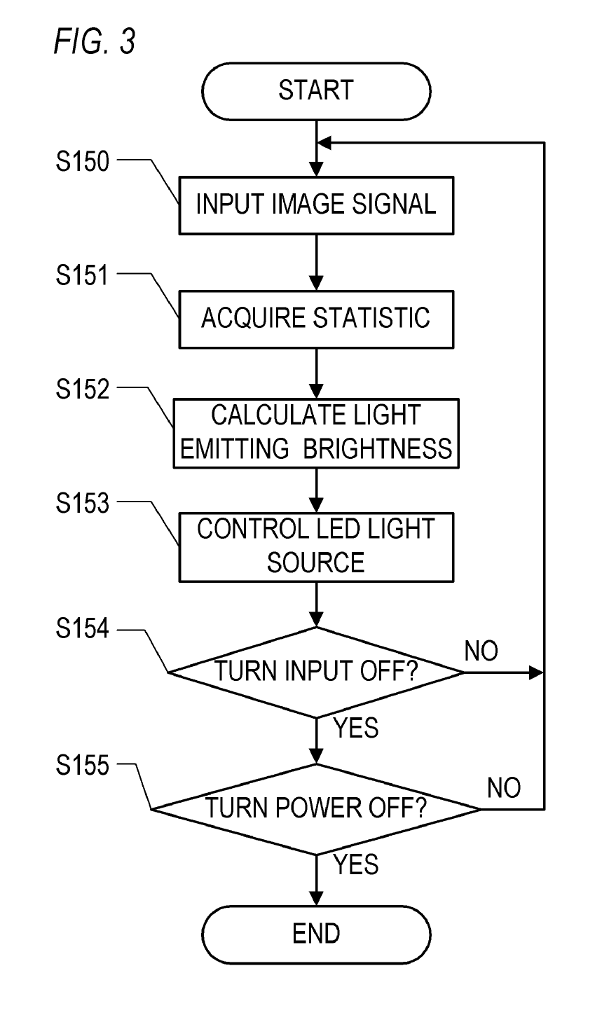

FIG. 3 is a flowchart showing an example of the operation of the image display apparatus 100 according to this embodiment.

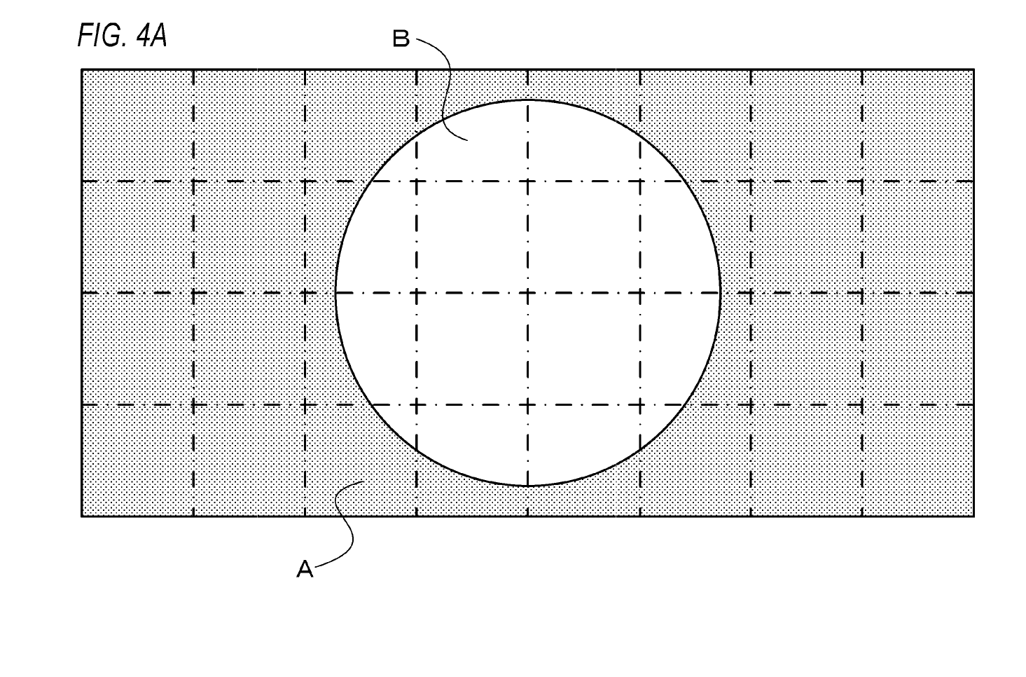

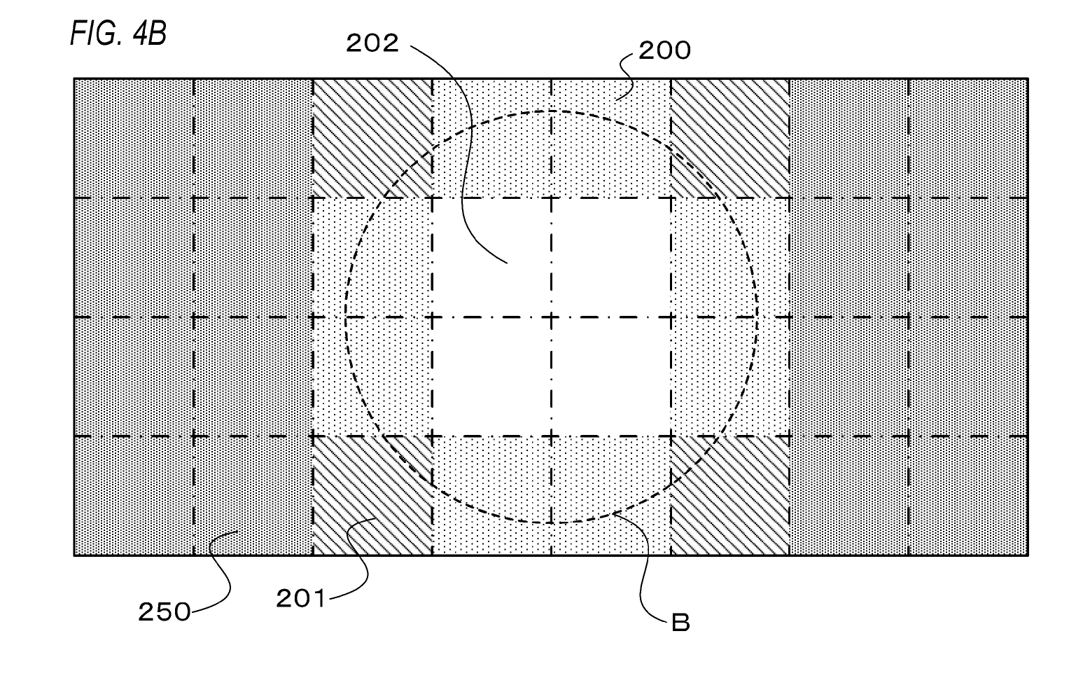

FIG. 4A is a diagram showing an example of the image signal input to the image display apparatus 100. Specifically, FIG. 4A shows a signal of an image in which a bright round object B is in a dark background A.

FIG. 4B is a diagram showing an example of the light emitting brightness of each block when the image signal of FIG. 4A is input.

In the example of FIGS. 4A and 4B, as with FIG. 2, the area of the screen is divided into a total of 32 blocks; namely, 8×4 blocks.

The operation of the image display apparatus 100 is now explained with reference to FIG. 3 and FIGS. 4A and 4B.

Foremost, the input unit 110 writes the input image signal in a memory (S150).

Subsequently, the statistic acquisition unit 111 reads the input image signal (image signal written in the memory) from the memory by dividing the image signal into each block (S151). In addition, the statistic acquisition unit 111 acquires the statistic of the read image signal of each block.

Among the image signals acquired in S151, the image signals of the four blocks 202 are the image signals that contain only the object B.

The image signals of the six blocks 200 are the image signals that contain approximately 1/2 of the object B and the background A, respectively.

The image signals of the four blocks 201 are the image signals that contain approximately 1/8 of the object B, and approximately 7/8 of the background A.

The image signals of the sixteen blocks 250 are the image signals that contain only the background A.

When the statistic of each block is acquired by the statistic acquisition unit 111, the correction value generation unit 112 detects, for each block, the bright portion and the dark portion (amount of bright portion and dark portion) in that block. In addition, the statistic acquisition unit 111 calculates the surface brightness and correction value of each block from the foregoing detection results.

The image processing unit 113 performs image processing to the image signal for each block by using the correction value calculated by the statistic acquisition unit 111, and outputs the processed image signal to the liquid crystal display unit 114.

The liquid crystal display unit 114 controls the transmittance of each liquid crystal device based on the input image signal (image signal to which image processing was performed) of each block.

Based on the foregoing processing, the transmittance of the liquid crystal display unit 114 becomes the transmittance based on the image signal in which consideration is given to the brightness and color of the light from the backlight apparatus.

Subsequent to S151, the brightness gain generation unit 115 calculates the average brightness of the image signal of each block from the statistic of each block acquired in S151. In addition, the brightness gain generation unit 115 calculates the light emitting brightness of each block of the LED drive circuit 116 from the calculated average brightness of each block, and transmits the calculation results (light emitting brightness of each block) to the LED drive circuit 116 (S152).

Subsequently, the LED drive circuit 116 controls the LED light source unit 117 so that the light emitting brightness of each block becomes the value calculated in S152 (S153). Consequently, the LED light source unit 117 emits light, for each block, at the brightness based on the image signal of that block.

As a result, the respective blocks of the LED light source unit 117 emit light so that the light emitting brightness becomes higher with the blocks with more areas of the bright object B in comparison to the blocks with less areas as shown in FIG. 4B. For example, in FIG. 4B, the light emitting brightness of the block 202 containing only the object B is set high, and the block 250 containing only the background A is unlit.

Subsequent to S153, the input unit 110 determines whether the input of the image signal has been turned OFF (has been lost) (S154). When the input of the image signal has been turned OFF (S154: YES), the processing proceeds to S155, and when the input of the image signal has not been turned OFF (S154: NO), the processing returns to S150.

In S155, the input unit 110 determines whether the power of the image display apparatus 100 has been turned OFF. When the power of the image display apparatus 100 has been turned OFF (S155: YES), this flow is ended, and when the power of the image display apparatus 100 has not been turned OFF (S155: NO), the processing returns to S150.

As described above, according to this embodiment, it is possible to inhibit the generation of unintended coloring around the block, as well as inhibit color unevenness and brightness unevenness.

Specifically, the backlight apparatus of this embodiment is configured such that local dimming control is possible (light emitting brightness and emission color can be controlled for each block). In addition, a plurality of white LEDs and a plurality of primary color LEDs capable of realizing a white light based on color mixture are disposed in the respective blocks of the backlight apparatus. Consequently, the light emitting brightness of each block can be changed while maintaining the white balance. As a result, it is possible to inhibit the color unevenness and brightness unevenness of the light from the backlight apparatus.

Moreover, with this embodiment, the plurality of LEDs of each block are arranged in a matrix so that the white LEDs are positioned at the four corners where color mixture with light from the other LEDs is most difficult. Consequently, since the color of light that leaks from the periphery of the block approximates white, it is possible to inhibit the generation of unintended coloring around the block in cases where, for instance, a plurality of LEDs of one block are independently lit. Moreover, as a result of being able to inhibit the generation of the foregoing coloring, the color unevenness and brightness unevenness can be further inhibited.

### Embodiment 2

Embodiment 2 of the present invention is now explained.

Embodiment 2 explains a configuration of the backlight apparatus capable of yielding the effects explained in Embodiment 1 as well as achieving a thinner profile. Note that, since the basic configuration of the image display apparatus (liquid crystal display apparatus) is the same as Embodiment 1, the explanation thereof is omitted.

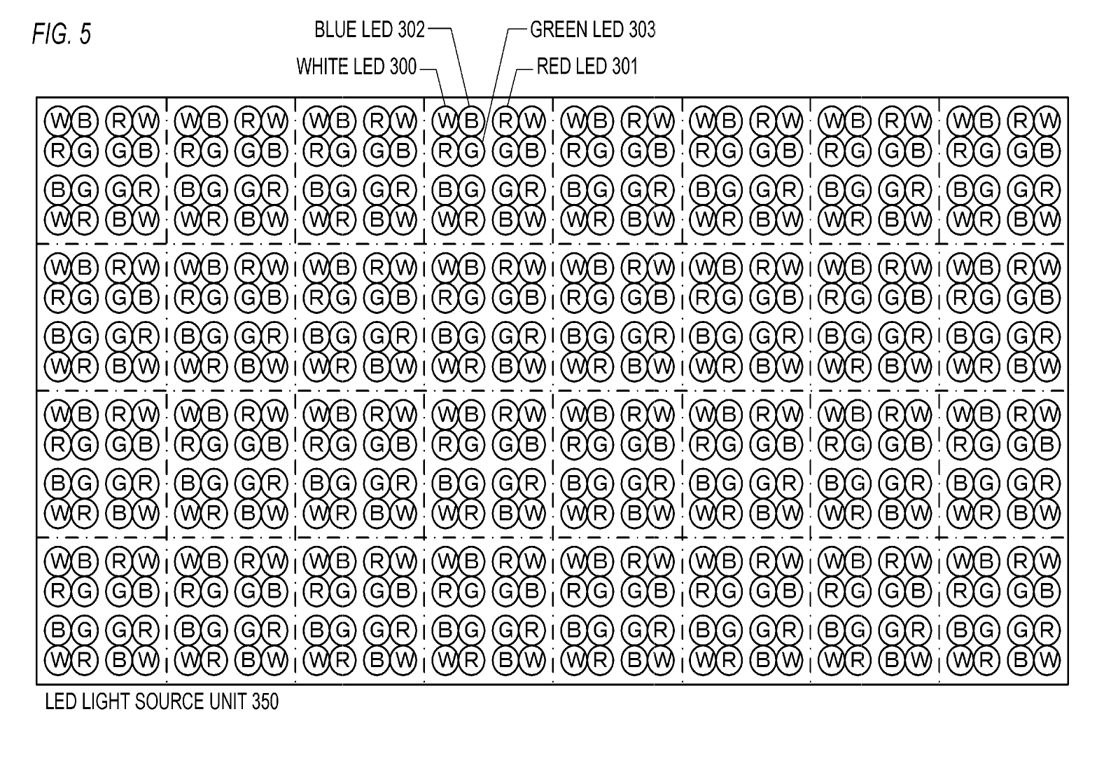

FIG. 5 is a diagram showing an example of the arrangement of the LEDs in the LED light source unit 350 (backlight apparatus) according to this embodiment.

In this embodiment, as shown in FIG. 5, the plurality of primary color LEDs of each block include a plurality of red LEDs, a plurality of green LEDs, and a plurality of blue LEDs. In addition, the plurality of LEDs of each block are arranged in a matrix so that the green LEDs are concentrated at the central portion.

Specifically, the green LED 303 of each group is disposed at the central portion side of the block.

Since the remainder of the configuration is the same as Embodiment 1, the explanation thereof is omitted.

When a thinner profile of the backlight apparatus capable of obtaining a white light by using a white LED and a plurality of primary color LEDs is achieved, the space (diffusion space) for diffusing light from the LED becomes small. Thus, light from a part of the light emitting surface becomes bluish white or reddish white light, and color unevenness sometimes occurs.

In order to inhibit this kind of color unevenness and obtain a uniform white light in the light emitting surface, it is necessary to adjust the luminous intensity of each of the plurality of primary color lights sources. Generally speaking, it is known that when R (luminous intensity of red light):G (luminous intensity of green light):B (luminous intensity of blue light) is set to be roughly 3:7:1, the lights thereof (red light, green light, blue light) can be efficiently subject to color mixing. Thus, if the red LED, the green LED, and the blue LED are caused to emit light at the foregoing luminous intensity ratio, color mixing can be performed efficiently and, even when a thin profile of the backlight apparatus is achieved, a uniform white light can be obtained in the light emitting surface (foregoing color unevenness can be inhibited).

For example, when the luminous intensity of the red LED is set to 125 mcd, in order to achieve the foregoing ratio, it is necessary to set the luminous intensity as follows:

luminous intensity of the green LED=125×7/3=291.6 mcd, and

luminous intensity of the blue LED=125×1/3=41.6 mcd.

Nevertheless, since the luminous intensity of the green LED 303 is weak, it is not possible to cause one green LED 303 to emit light at the foregoing luminous intensity. In this embodiment, by concentrating a plurality of green LEDs 303 at the central portion of the block, it is possible to realize a green light of the foregoing luminous intensity based on the plurality of green LEDs 303. Consequently, a plurality of primary color lights (red light, green light, and blue light) are efficiently subject to color mixing in one block, and it is possible to inhibit the color unevenness that occurs when the backlight apparatus is thinned.

As described above, according to this embodiment, based on a configuration that is similar to Embodiment 1, it is possible to inhibit the generation of unintended coloring around the block as well as inhibit color unevenness and brightness unevenness. In addition, with this embodiment, as a result of disposing a plurality of green LEDs so that they are concentrated at the central portion of the block, the color mixture of the plurality of primary color lights can be performed efficiently. Consequently, it is possible to reduce the size of the diffusion space, and thereby achieve a thinner profile of the backlight apparatus.

### Embodiment 3

Embodiment 3 of the present invention is now explained.

This embodiment explains a configuration of the backlight apparatus in which the number of groups contained in one block is different from Embodiment 1. Note that, since the basic configuration of the image display apparatus (liquid crystal display apparatus) is the same as Embodiment 1, the explanation thereof is omitted.

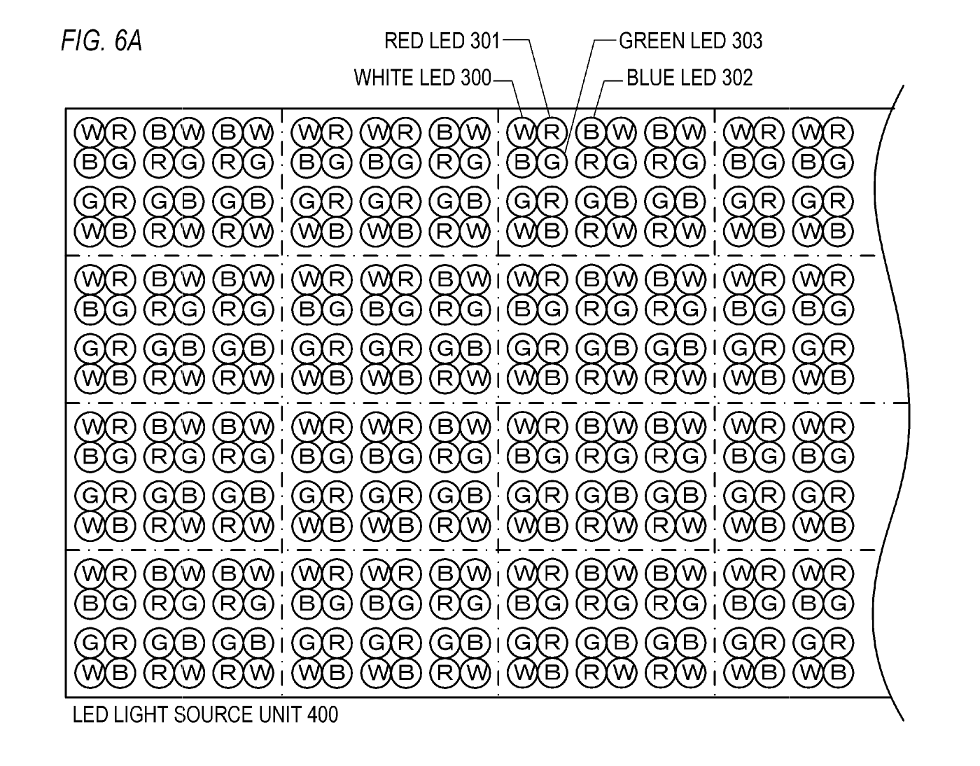

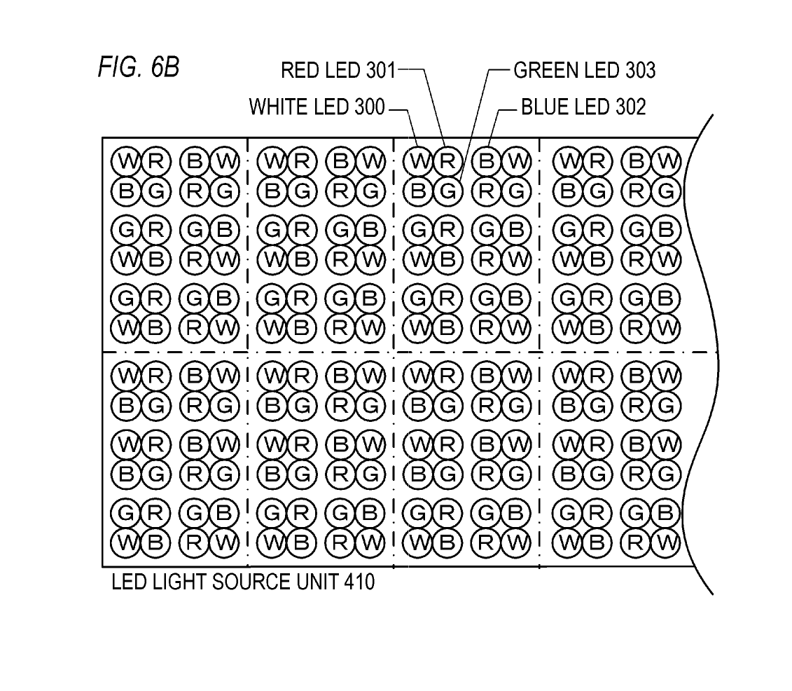

FIGS. 6A and 6B are diagrams showing an example of the arrangement of the LEDs in the LED light source units 400 and 410 (backlight apparatus) according to this embodiment.

FIGS. 6A and 6B are examples where six groups of the group shown in FIG. 1 are provided to one block. Specifically, FIG. 6A shows an example where the plurality of LEDs of each block are configured from six groups arranged in a 3×2 matrix. FIG. 6B shows an example where the plurality of LEDs of each block are configured from six groups arranged in a 2×3 matrix.

In the examples of FIGS. 6A and 6B also, as with Embodiment 1, the plurality of LEDs of each block are arranged in a matrix so that the white LEDs 300 are positioned at the four corners.

Moreover, among the plurality of groups arranged in a matrix, the plurality of LEDs of a group that are not positioned at the four corners are arranged so that the white LEDs 300 are positioned outside. Specifically, the plurality of LEDs of the groups of the positions (2 (horizontal direction), 1 (vertical direction)) and (2, 2) of FIG. 6A are arranged so that the white LEDs 300 are positioned outside, respectively. The plurality of LEDs of the groups of the positions (1 (horizontal direction), 2 (vertical direction)) and (2, 2) of FIG. 6B are arranged so that the white LEDs 300 are positioned outside, respectively. As a result of arranging the white LEDs 300 outside as described above, more light that leaked from the blocks can be made to be white light, and it is thereby possible to inhibit the generation of unintended coloring around the block, as well as inhibit color unevenness and brightness unevenness.

As described above, according to this embodiment, based on a configuration that is similar to Embodiment 1, it is possible to inhibit the generation of unintended coloring around the block as well as inhibit color unevenness and brightness unevenness. In addition, with this embodiment, among the plurality of groups arranged in a matrix, as a result of arranging the plurality of LEDs of a group that is not positioned at the four corners so that the white LEDs are positioned outside, it is possible to further inhibit the foregoing coloring, color unevenness, and brightness unevenness.

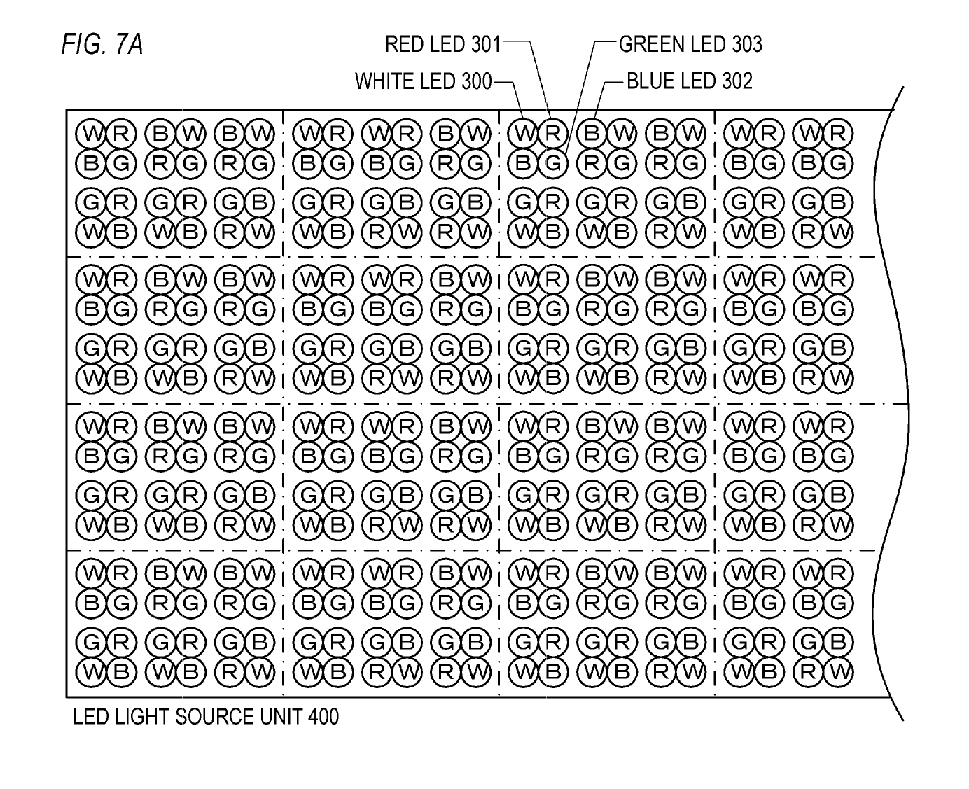

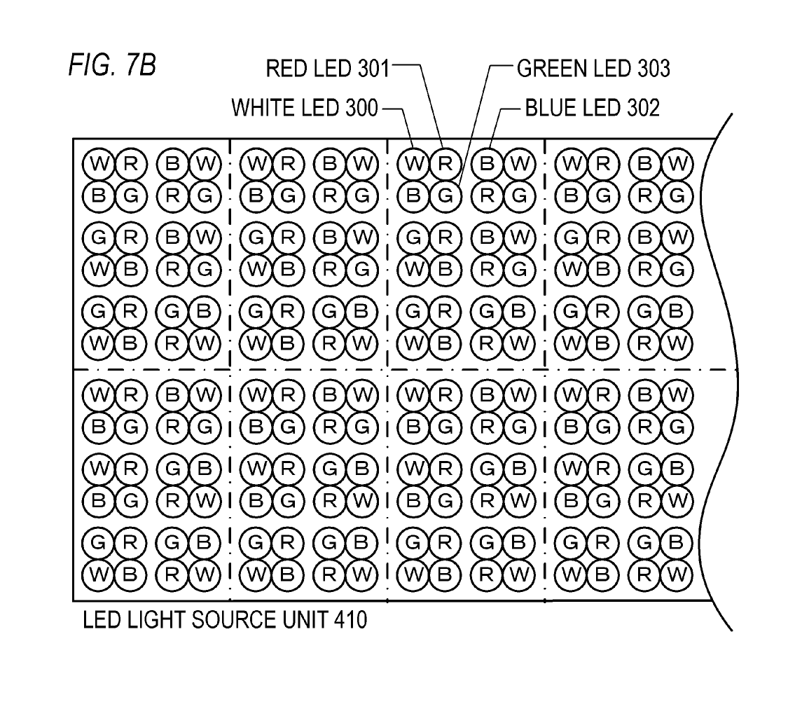

Note that the LEDs in the LED light source units 400 and 410 (backlight apparatus) may also be arranged as shown in FIGS. 7A and 7B.

FIG. 7A differs from FIG. 6A with respect to the group of the position (2, 2) of each block. FIG. 7B differs from FIG. 6B with respect to the group of the position (2, 2) of each block. Specifically, in FIGS. 6A and 6B, the white LEDs 300 of the group of the position (2, 2) of each block are arranged to be adjacent to the white LEDs 300 of the other blocks. Meanwhile, in the example of FIGS. 7A and 7B, the white LEDs 300 are arranged so that they are not adjacent to the other white LEDs 300.

As a result of arranging the white LEDs 300 as described above, it is possible to reduce the polarization of light from the white LEDs 300 in comparison to the case where the white LEDs 300 are arranged to be adjacent to the other white LEDs 300, and thereby further reduce color unevenness and brightness unevenness.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-192803, filed on Sep. 5, 2011, which is hereby incorporated by reference herein in its entirety.

What is claimed is:

1. A lighting apparatus configured from a plurality of blocks controllable individually for brightness or color, wherein
each of the blocks comprises a plurality of light emitting devices including a plurality of white light emitting devices and a plurality of colored light emitting devices, and
the plurality of light emitting devices of each of the blocks are arranged in a matrix so that the white light emitting devices are positioned at four corners.

2. The lighting apparatus according to claim 1, wherein
the plurality of colored light emitting devices include a plurality of red light emitting devices, a plurality of green light emitting devices, and a plurality of blue light emitting devices, and
the plurality of light emitting devices of each of the blocks are arranged in a matrix so that the green light emitting devices are concentrated at a central portion.

3. The lighting apparatus according to claim 1, wherein
the plurality of light emitting devices of each of the blocks are configured from a plurality of groups arranged in a matrix, and
the group is configured from one or more white light emitting devices and a plurality of colored light emitting devices arranged in a matrix.

4. The lighting apparatus according to claim 3, wherein the group is configured from four light emitting devices, which are one white light emitting device, one red light emitting device, one green light emitting device, and one blue light emitting device arranged in a matrix.

5. The lighting apparatus according to claim 3, wherein the plurality of light emitting devices of each of the blocks are configured from four groups arranged in a 2×2 matrix.

6. The lighting apparatus according to claim 1, wherein the lighting apparatus is a direct-type backlight apparatus disposed on a back face side of a liquid crystal panel.

7. A liquid crystal display apparatus, comprising:
a liquid crystal panel; and
the lighting apparatus according to claim 1.

8. A method of controlling the liquid crystal display apparatus according to claim 7,
the method comprising:
a step of controlling, for each block, brightness or color of the lighting apparatus based on an input image signal; and
a step of controlling, for each block, transmittance of the liquid crystal panel based on the image signal.
